(19) United States
(12) Patent Application Publication
(10) Pub. No.: US 2016/0320542 A1
(43) Pub. Date: Nov. 3, 2016

(54) BACKLIGHT UNIT WITH HEAT DISSIPATING MEMBER AND LIQUID CRYSTAL DISPLAY DEVICE INCLUDING THE SAME

(71) Applicant: Samsung Display Co., Ltd., Yongin-City (KR)

(72) Inventors: Junwoo YOU, Seongnam-si (KR); Atsushi NEMOTO, Suwon-si (KR)

(21) Appl. No.: 14/851,053

(22) Filed: Sep. 11, 2015

(30) Foreign Application Priority Data
Apr. 30, 2015 (KR) 10-2015-0061130

(51) Int. Cl. F21V 8/00; G02F 1/1333

(52) U.S. Cl. CPC G02B 6/009; G02B 6/0073; G02B 6/0085; G02F 1/133308

(57) ABSTRACT

A backlight unit includes: a light source which generates a light; a printed circuit board on which the light source is mounted; and a lower frame in which the light source and the printed circuit board are accommodated The lower frame includes: a bottom portion having a planar shape; and a side wall portion bent from an edge of the bottom portion to extend therefrom. The side wall portion defines an aperture at the edge of the bottom portion, the printed circuit board is disposed at the aperture defined by the side wall portion of the lower frame, and a portion of the printed circuit board disposed at the aperture is exposed to outside the backlight unit.

This application claims priority to Korean Patent Application No. 10-2015-0061130, filed on Apr. 30, 2015, and all the benefits accruing therefrom under 35 U.S.C. §119, the disclosure of which is incorporated herein in its entirety by reference.

### BACKGROUND

1. Field

Exemplary embodiments of the invention relate to a backlight unit and a liquid crystal display (“LCD”) device including the same, and more particularly, to a backlight unit having enhanced heat dissipation efficiency and an LCD device including the same.

2. Description of the Related Art

Display devices are classified into types including liquid crystal display (“LCD”) devices, organic light emitting diode (“OLED”) display devices, plasma display panel (“PDP”) devices, electrophoretic display (“EPD”) devices, and the like, based on a light emitting scheme thereof.

An LCD device is a passive-matrix light emitting device including a display panel and a backlight unit generating and providing light to the display panel. Such an LCD device includes two opposing display panel substrates, electrodes respectively disposed in the two display panel substrates, and a liquid crystal layer interposed between the display panel substrates. In an LCD device, orientations of liquid crystal molecules of the liquid crystal layer are rearranged upon voltages being applied to the electrodes, and thereby the amount of light emitted from a backlight unit is adjusted in the LCD device.

A backlight unit is classified into types including a direct-type backlight unit, an edge-type backlight unit, a corner-type backlight unit and the like, based on a position of a light source within the backlight unit. In a direct-type backlight unit, a plurality of light sources are disposed below and overlapping a display panel, and light emitted from the light source is irradiated toward the display panel through a diffusion plate of the backlight unit. An edge-type backlight unit includes a light guide plate and light sources which are arranged at a side of the light guide plate of the backlight unit, and light emitted laterally from the light source is irradiated toward a display panel through the light guide plate.

A light source used in a backlight unit includes a point light source, such as a light emitting diode (“LED”). Since more than about 70% to about 80% of power input to an LED is converted into thermal energy, heat dissipation efficiency may be key to the LED development. In particular, a temperature rise of an LED due to such heat is directly associated with a decrease in light efficiency of the backlight unit including the light source. Accordingly, enhancing heat dissipation efficiency of the backlight unit may be essential in order to reduce or effectively prevent the deterioration of a light source and to enhance an overall performance of an LCD device including the light source.

### SUMMARY

One or more exemplary embodiments of the invention are directed to a backlight unit having enhanced heat dissipation efficiency and a liquid crystal display (“LCD”) device including the same.

According to an exemplary embodiment of the invention, a backlight unit includes: a light source which generates a light; a printed circuit board (“PCB”) on which the light source is mounted; and a lower frame in which the light source and the printed circuit board are accommodated. The lower frame includes: a bottom portion having a planar shape; and a side wall portion bent from an edge of the bottom portion to extend therefrom. The side wall portion defines an aperture at the edge of the bottom portion, the printed circuit board is disposed at the aperture defined by the side wall portion of the lower frame, and a portion of the printed circuit board disposed at the aperture is exposed outside the backlight unit.

The aperture may have a substantially same area as that of a surface of the printed circuit board which is disposed at the aperture.

The light source may be a light emitting diode (“LED”).

The printed circuit board may be one of a metal printed circuit board (“MPCB”) and a metal core printed circuit board (“MCPCB”).

The printed circuit board may include at least one of stainless steel, aluminum, an aluminum alloy, magnesium, a magnesium alloy, copper, a copper alloy and an electro-galvanized steel sheet.

The printed circuit board which is disposed at the aperture may be coupled to the bottom portion and heat may be transferred between the printed circuit board and the bottom portion coupled to each other.

The printed circuit board which is disposed at the aperture may be screw-coupled to the bottom portion and the heat may be transferred between the printed circuit board and the bottom portion screw-coupled to each other.

The backlight unit may further include a light source unit including therein: the light sourced which generates the light, the printed circuit board which is disposed at the aperture, and an insulating layer between the light source and the printed circuit board.

The printed circuit board may have a thickness in a range of about 0.5 millimeters (mm) to about 3.0 millimeters (mm).

The backlight unit may further include a heat-dissipating extrusion bar coupled to the printed circuit board which is disposed at the aperture. Heat may be transferred between the heat-dissipating extrusion bar and the printed circuit board coupled to each other, and the heat-dissipating extrusion bar may be disposed above the light source.

The heat-dissipating extrusion bar may be screw-coupled to the printed circuit board which is disposed at the aperture and the heat may be transferred between the heat-dissipating extrusion bar and the printed circuit board screw-coupled to each other.

The heat-dissipating extrusion bar may include at least one of stainless steel, aluminum, an aluminum alloy, magnesium, a magnesium alloy, copper, a copper alloy and an electro-galvanized steel sheet.

The backlight unit may further include a heat-dissipating tape attached to a surface of the printed circuit board which is disposed at the aperture, the surface of the printed circuit board to which the heat-dissipating tape is attached being exposed outside the backlight unit.

The heat-dissipating tape may define a microcavity structure.

According to another exemplary embodiment of the invention, a liquid crystal display (“LCD”) device includes: a display panel which displays an image using a light; and a backlight unit which provides the light to the display panel. The backlight unit includes: a light source which generates and provides the light; a printed circuit board (“PCB”) on which the light source is mounted; and a lower frame in which the display panel, the light source and the printed circuit board are accommodated. The lower frame includes: a bottom portion having a planar shape; and a side wall portion bent from an edge of the bottom portion to extend therefrom. The side wall portion defines an aperture at the edge of the bottom portion, the printed circuit board is disposed at the aperture defined by the side wall portion of the lower frame, and a portion of the printed circuit bard disposed at the aperture is exposed outside the backlight unit.

The aperture may have a substantially same area as that of a surface of the printed circuit board which is disposed at the aperture.

The printed circuit board which is disposed at the aperture may be coupled to the bottom portion, and heat may be transferred between the printed circuit board and the bottom portion coupled to each other.

The liquid crystal display device may further include a heat-dissipating extrusion bar coupled to the printed circuit board which is disposed at the aperture. Heat may be transferred between the heat-dissipating extrusion bar and the printed circuit board coupled to each other, and the heat-dissipating extrusion bar coupled to the printed circuit board may be disposed above the light source.

The heat-dissipating extrusion bar may define a support portion thereof which supports the display panel thereon.

The liquid crystal display device may further include a heat-dissipating tape attached to a surface of the printed circuit board which is disposed at the aperture, the surface of the printed circuit board to which the heat-dissipating tape is attached being exposed outside the backlight unit.

According to one or more exemplary embodiments, the backlight unit with one or more heat dissipating members and the LCD device including the same may enhance heat dissipation efficiency by a metal-material PCB having relatively high thermal conductivity and having a predetermined thickness, and by exposing the highly thermally conductive PCB directly to an external environment relative to the backlight unit.

In addition, the backlight unit with one or more heat dissipating members and the LCD device including the same may enhance heat dissipation efficiency by thermally contacting the PCB, on which the light source is mounted, to the metal frame (e.g., a lower frame, a extrusion bar, etc.) which accommodates the respective components of the LCD device therein.

Further, the backlight unit with one or more heat dissipating members and the LCD device including the same may include the heat-dissipating tape as a heat dissipating member, where the heat-dissipating tape has the microcavity structure and the microcavity-structure heat-dissipating tape is disposed on the externally exposed portion of the PCB on which the light source is mounted.

The foregoing is illustrative only and is not intended to be in any way limiting. In addition to the illustrative embodiments, and features described above, further embodiments, and features will become apparent by reference to the drawings and the following detailed description.

### BRIEF DESCRIPTION OF THE DRAWINGS

The above and other features of the present disclosure of invention will be more clearly understood from the following detailed description taken in conjunction with the accompanying drawings, in which:

FIG. 1 is an exploded perspective view illustrating an exemplary embodiment of a liquid crystal display (“LCD”) device according to the invention;

FIG. 2 is a cross-sectional view taken along line I-I′ of FIG. 1;

FIG. 3 is a perspective view illustrating an exemplary embodiment of an extrusion bar according to the invention;

FIG. 4 is an enlarged electron-microscope image depicting an exemplary embodiment of a portion of a heat dissipation tape according to the invention;

FIG. 5A is an exploded perspective view schematically illustrating an exemplary embodiment of a backlight unit according to the invention;

FIG. 5B is a perspective view illustrating an assembled state of the backlight unit of FIG. 5A;

FIG. 6A is an exploded perspective view schematically illustrating another exemplary embodiment of a backlight unit according to the invention;

FIG. 6B is a perspective view illustrating an assembled state of the backlight unit of FIG. 6A; and

FIG. 7 is a cross-sectional view schematically illustrating a path of heat generated in a light source of an exemplary embodiment of a backlight unit according to the invention.

### DETAILED DESCRIPTION

Exemplary embodiments will now be described more fully hereinafter with reference to the accompanying drawings.

However, the invention may be embodied in different forms and should not be construed as limited to the exemplary embodiments set forth herein. Rather, these exemplary embodiments are provided so that this disclosure will be thorough and complete, and will fully convey exemplary implementations to those skilled in the art.

Throughout the specification, when an element is referred to as being “connected” to another element, the element is “physically connected” to the other element or “electrically connected” to the other element with one or more intervening elements interposed therebetween. When an element is referred to as being “directly connected” to another element, the element is “directly physically connected” to the other element or “directly electrically connected” to the other element with no intervening elements interposed therebetween.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” and the like, may be used herein to describe various elements, components, areas, layers and/or sections, these elements, components, areas, layers and/or sections should not be limited by these terms. These terms are only used to distinguish one element, component, area, layer or section from another element, component, area, layer or section. Thus, a first element, component, area, layer or section discussed below could be termed a second element, component, area, layer or section without departing from the teachings of exemplary embodiments.

When it is determined that a detailed description may make the purpose of the invention unnecessarily ambiguous in the description of the invention, such a detailed description will be omitted. In addition, the same components and corresponding components are given the same reference numeral.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of a display device according to the invention are explained with respect to a liquid crystal display (“LCD”) device including an edge-type backlight unit, but the invention is not limited thereto.

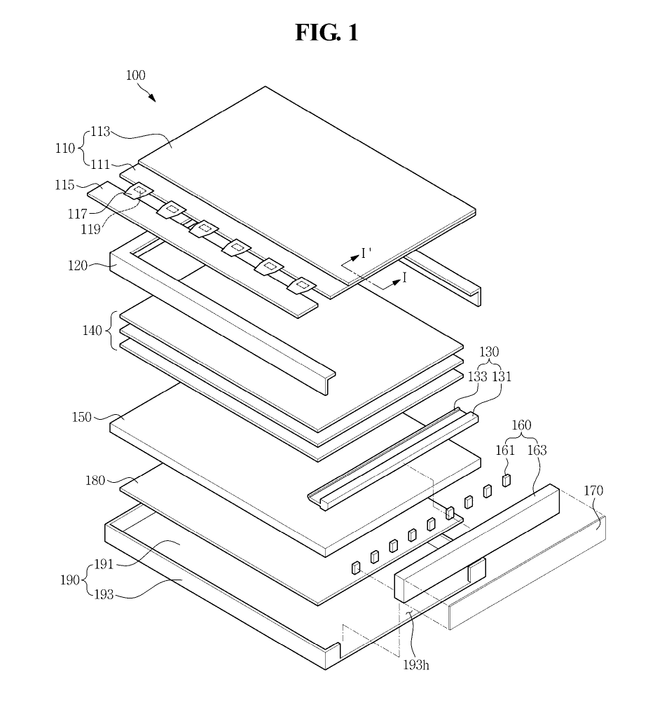

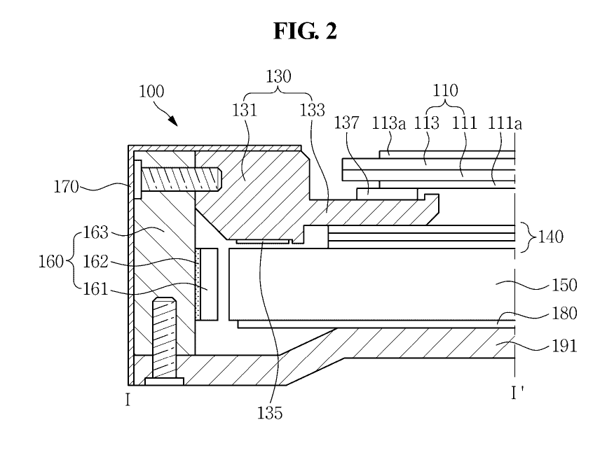

FIG. 1 is an exploded perspective view illustrating an exemplary embodiment of an LCD device 100 according to the invention. FIG. 2 is a cross-sectional view taken along line I-I′ of FIG. 1.

Referring to FIGS. 1 and 2, the LCD device 100 includes a display panel 110, an intermediate frame 120, an extrusion bar 130, an optical sheet 140, a light guide plate 150, a light source unit 160, a heat dissipation sheet such as a heat dissipation tape 170, a reflective sheet 180, a lower frame 190 and the like.

As used herein, the intermediate frame 120, the extrusion bar 130, the optical sheet 140, the light guide plate 150, the light source unit 160, the heat dissipation tape 170, the reflective sheet 180, the lower frame 190 and the like, are collectively referred to as a backlight unit.

The display panel 110 may be provided in a quadrangular planar shape and displays an image by receiving an externally applied electric signal. The display panel 110 may include a first display substrate 111, a second display substrate 113 opposing the first display substrate 111, and a liquid crystal layer (not illustrated) between the first and second display substrates 111 and 113.

The first display substrate 111 may include a plurality of pixel electrodes arranged in a matrix form on a first base substrate, a thin film transistor applying a driving voltage to each of the pixel electrodes on the first base substrate, and various signal lines for driving the pixel electrode and the thin film transistor on the first base substrate.

The second display substrate 113 may be disposed to oppose the first display substrate 111, and may include a common electrode including or formed of a transparent conductive material, and a color filter, on a second base substrate. The color filter may include red, green and blue color filters, by way of example, but the invention is not limited thereto.

The liquid crystal layer (not illustrated) may be interposed between the first and second display substrates 111 and 113, and orientations of liquid crystal molecules of the liquid crystal layer may be rearranged by an electric field formed between the pixel electrode and the common electrode. The rearranged liquid crystal layer may adjust a level of transmittance of light emitted from the backlight unit, the light having the adjusted level of transmittance may be transmitted through the color filter, and an image may be displayed outwardly at a viewing side of the LCD device 100.

A lower polarizing plate 111a and an upper polarizing plate 113a may further be disposed on a lower surface of the first display substrate 111 and an upper surface of the second display substrate 113, respectively. The upper polarizing plate 113a and the lower polarizing plate 111a may each have a planar area corresponding to a planar area of the display panel 110 in size.

The upper polarizing plate 113a may allow a predetermined component of polarized light from among externally supplied light to pass therethrough, and may absorb or block the remainder of the externally supplied light. The lower polarizing plate 111a may allow a predetermined component of polarized light from among the light emitted from the backlight unit to pass therethrough, and may absorb or block the remainder of the light emitted from the backlight unit.

A driving circuit board 115 may be disposed laterally of at least one side of the display panel 110. The driving circuit board 115 may provide various control signals and power signals to the display panel 110 for driving the display panel 110.

The display panel 110 and the driving circuit board 115 may be electrically connected to one another by at least one flexible printed circuit board (“FPCB”) 117. The FPCB 117 may be a chip-on-film (“COF”) structure or a tape-carrier-package (“TCP”) structure, and the number of FPCBs 117 may vary based on, for example, a size and a driving scheme, of the display panel 110.

A driving chip 119 may be mounted on the FPCB 117. The driving chip 119 may generate various driving signals for driving the display panel 110. The driving chip 119 may be a single chip in which a timing controller and a data driving circuit are integrated with one another, and may also be referred to as, for example, a driver integrated circuit (“IC”) or a source integrated circuit (“IC”).

The intermediate frame 120 may support a lower edge of the display panel 110, and may define a space in which the optical sheet 140, the light guide plate 150, the light source unit 160, the reflective sheet 180 and the like are accommodated.

The intermediate frame 120 may have a polygonal frame shape to define an opening therein. In an exemplary embodiment, for example, the intermediate frame 120 may have an overall quadrangular frame shape which defines an opening therein. The intermediate frame 120 may be provided as a single, unitary frame, or alternatively, may be formed by a plurality of divided portions. In the exemplary embodiment, the intermediate frame 120 may have a polygonal frame shape in which at least a side thereof at which the light source unit 160 is disposed is omitted.

The intermediate frame 120 may include at least one of an epoxy resin composition; a silicon resin composition; a modified epoxy resin composition such as a silicon-modified epoxy resin; a modified silicon resin composition such as an epoxy-modified silicon resin; a polyimide resin composition; a modified polyimide resin composition; polyphthalamide (“PPA”); a polycarbonate (“PC”) resin; polyphenylene sulfide (“PPS”); a liquid crystal polymer (“LCP”); an acrylonitrile butadiene styrene (“ABS”) resin; a phenol resin; an acrylic resin; and a polybutylene terephthalate (“PBT”) resin.

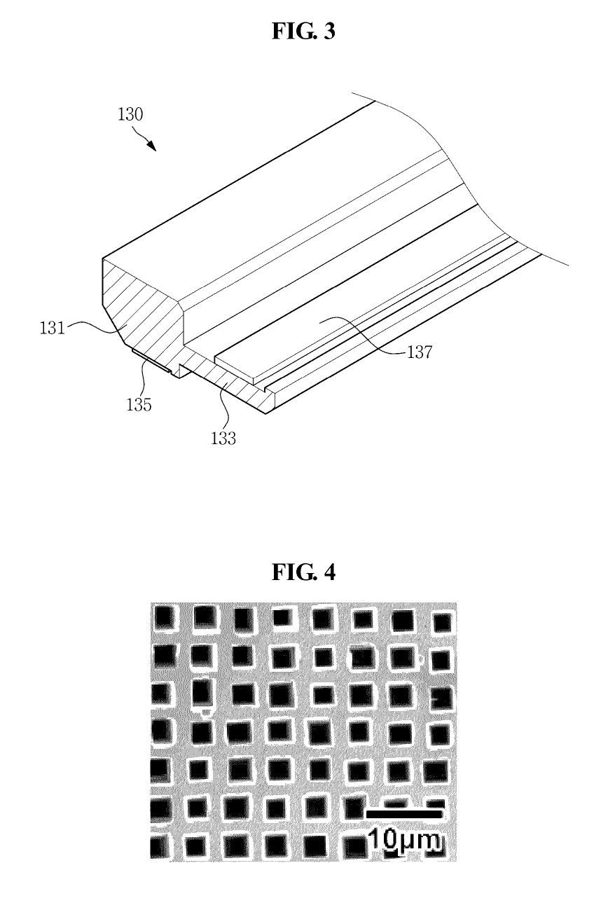

FIG. 3 is a perspective view illustrating an exemplary embodiment of an extrusion bar according to the invention.

Referring to FIGS. 1, 2 and 3, the extrusion bar 130 may externally dissipate heat generated in the light source unit 160, and may support a lower edge of the display panel 110. Where the intermediate frame 120 has the polygonal frame shape in which a side thereof at which the light source unit 160 is disposed is omitted, the extrusion bar 130 may support the lower edge of the display panel 110 at the side at which the light source unit 160.

The extrusion bar 130 may define a fixing portion 131 which is coupled to a printed circuit board (“PCB”) 163 of the light source unit 160, and a support portion 133 extending from the fixing portion 131 and supporting the lower edge of the display panel 110. The extrusion bar 130 may be screw-coupled to the PCB 163, but the invention is not limited thereto. In exemplary embodiments, the shape of the extrusion bar 130 is not limited there above-described structure, and the extrusion bar 130 may have various shapes. The PCB 163 may contact the extrusion bar 130 to transfer heat therebetween, but the invention is not limited thereto.

The extrusion bar 130 may include a metal having a relatively high thermal conductivity, for example, at least one of stainless steel, aluminum (Al), an Al alloy, magnesium (Mg), a magnesium (Mg) alloy, copper (Cu), a copper (Cu) alloy and an electro-galvanized steel sheet.

A buffer 135 may be disposed on a lower surface of the fixing portion 131. A fixing member such as an adhesive 137 which fixes the display panel 110 relative to the extrusion bar 130 may further be disposed on an upper surface of the support portion 133 of the extrusion bar 130.

Referring to FIGS. 1 and 2, the optical sheet 140 may be disposed on the light guide plate 150, and may serve to diffuse or collimate light transmitted from the light guide plate 150. The optical sheet 140 may collectively include a diffusion sheet, a prism sheet and a protective sheet. The diffusion sheet, the prism sheet and the protective sheet may be sequentially stacked on the light guide plate 150.

The prism sheet may collimate light guided and emitted by the light guide plate 150, the diffusion sheet may diffuse light collimated by the prism sheet, and the protective sheet may protect the prism sheet. Light having passed through the protective sheet may be supplied to the display panel 110.

The light guide plate 150 may uniformly supply light, emitted laterally from the light source unit 160, to the display panel 110. The light guide plate 150 may have a quadrangular planar shape. According to embodiments, the light guide plate 150 may have various shapes including, for example, a predetermined groove or a protrusion, based on a position of a light source.

The light guide plate 150 is described herein as having a planar shape, that is, a plate, for ease of description. While the light guide plate 150 is described as a plate, such as having a relatively large cross-sectional thickness for ease of description, the invention is not limited thereto. According to embodiments, the light guide plate 150 may be provided in a sheet or film shape for which the cross-sectional thickness is smaller than that of the plate and is relatively small as compared to the planar size thereof, to achieve slimness of the display device. The light guide plate 150 is to be understood as having a concept that includes not only a plate but also a film which guides light provided from the light source unit 160.

The light guide plate 150 may include or be formed of a light-transmissive material, for example, an acrylic resin such as poly(methyl methacrylate) (“PMMA”) or polycarbonate (“PC”) to help guide light efficiently.

The light source unit 160 may include a light source 161 and the PCB 163 on which the light source 161 is mounted.

The light source 161 may be disposed at an edge or a light-incident side surface of the light guide plate 150. In other words, the light source 161 may emit light at least laterally toward the edge or the light-incident side surface of the light guide plate 150. The light source 161 may include a light emitting diode (“LED”) or an LED chip. In an exemplary embodiment, for example, the light source 161 may be a gallium nitride (GaN)-based LED which generates and emits blue light. A plurality of light sources 161 may be arranged along a length of the PCB 163. The number of the light sources 161 in the light source unit 160 may vary based on, for example, a size and luminance uniformity, of the display panel 110.

The PCB 163 may be one of a metal printed circuit board (“MPCB”) and a metal core printed circuit board (“MCPCB”). The PCB 163 may have a bar shape, having a relatively large length compared to a width thereof, defining an upper surface, a lower surface and side surfaces thereof. The PCB 163 may include a metal material having a relatively high thermal conductivity, for example, at least one of stainless steel, aluminum (Al), an Al alloy, magnesium (Mg), a magnesium (Mg) alloy, copper (Cu), a copper (Cu) alloy and an electro-galvanized steel sheet. A detailed description pertaining to the PCB 163 will be provided further below.

In the exemplary embodiment of the LCD device 100 according to the invention, a portion of the PCB 163 is exposed external to the lower frame 190, to thereby relatively rapidly dissipate high-temperature heat outwards from the LCD device 100 and the backlight unit thereof, which is generated from the light source 161.

In addition, an insulating layer 162 may further be disposed between the light source 161 and the PCB 163 including or formed of a metal.

The light source unit 160 may be disposed at one, two or four side surfaces of the light guide plate 150 based on, for example, a size and luminance uniformity, of the display panel 110. In other words, the light source unit 160 may be disposed at one or more edges of the light guide plate 150.

Although not illustrated in FIGS. 1 and 2, a wavelength converting unit (not illustrated) may be interposed between the light guide plate 150 and the light source unit 160. The wavelength converting unit may include a material which converts a wavelength of light provided thereto by the light source unit 160. In an exemplary embodiment, for example, the wavelength converting unit may convert a wavelength of blue light emitted from a blue LED light source to provide white light therefrom.

The heat dissipation tape 170 may be disposed on at least a surface of the PCB 163 of the light source unit 160. In particular, the heat dissipation tape 170 may be disposed on an outwardly-exposed surface of the PCB 163 which is exposed externally from the intermediate and lower frames 120 and 130.

FIG. 4 is an enlarged electron-microscope image depicting an exemplary embodiment of a portion of a heat dissipation tape according to the invention.

Referring to FIG. 4, the heat dissipation tape 170 may have a microcavity structure. The microcavity structure may include a plurality of micrometer-sized holes defined therein and are arranged in a regular manner along a plan view of the heat dissipation tape 170. The heat dissipation tape 170 may enhance heat dissipation efficiency based on a surface plasmon resonance phenomenon.

A surface plasmon is a type of electromagnetic wave generated on a metal surface including a light component. Surface plasmon resonance refers to a process in which a surface plasmon propagating along a metal surface is externally extracted using a microstructure or a nanostructure having the same wavelength as that of the surface plasmon which occurs on the metal surface.

Due to a heat generated in the light source 161, an infrared (“IR”) light or a light from thermal radiation within a range of about 10 micrometers (μm) may be generated on a surface of the PCB 163 including or formed of a metal. The heat dissipation tape 170 may externally emit the infrared light or the light from thermal radiation which is generated on the surface of the PCB 163, using the microcavity structure defined therein.

The heat dissipation tape 170 may increase emissivity of the infrared light generated on the surface of the PCB 163, thereby significantly enhancing radiant heat dissipation efficiency.

Referring to FIGS. 1 and 2, the reflective sheet 180 may include or be formed of, for example, polyethylene terephthalate (“PET”) to have reflectivity. One surface of the reflective sheet 180 may be coated with a diffusion layer containing, for example, titanium dioxide (TiO₂). The reflective sheet 180 may include or be formed of a material containing a metal, such as silver (Ag).

The lower frame 190 may maintain an overall framework of the LCD display device 100, and may protect various components accommodated therein. The lower frame 190 may define a bottom portion 191 and a side wall portion 193 which is bent from the bottom portion 191 to extend therefrom.

The side wall portion 193 may define an aperture 193h through which a portion of the PCB 163 is exposed outside the backlight unit. In an exemplary embodiment, for example, the aperture 193h may have substantially the same planar area as that of a surface of the PCB 163. In other words, in an exemplary embodiment, the lower frame 190 may have a shape in which a portion of the side wall portion 193 at which the light source unit 160 is positioned is omitted.

The lower frame 190 may include or be formed of a metal material having rigidity and relatively excellent heat dissipation properties. In an exemplary embodiment, for example, the lower frame 190 may include at least one of stainless steel, aluminum (Al), an Al alloy, magnesium (Mg), a Mg alloy, copper (Cu), a Cu alloy and an electro-galvanized steel sheet.

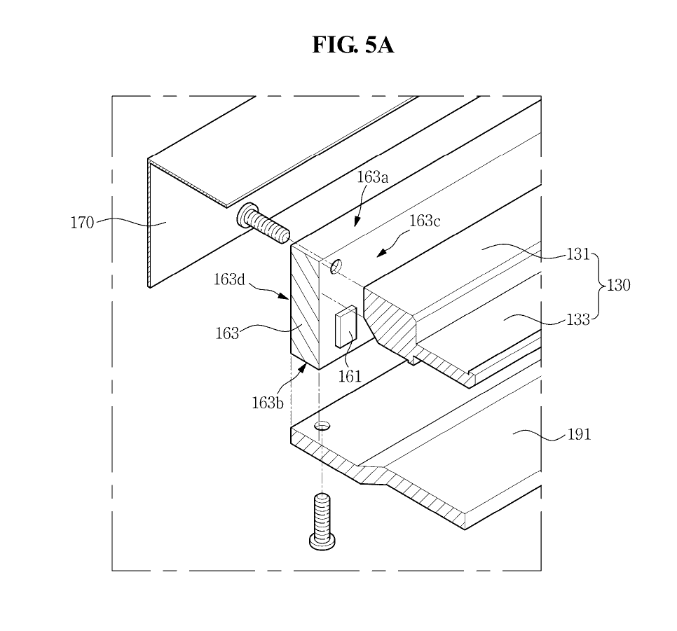

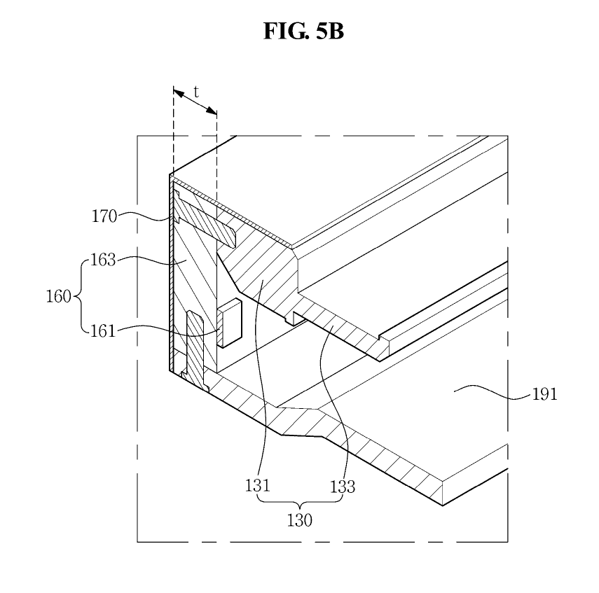

FIG. 5A is an exploded perspective view schematically illustrating an exemplary embodiment of a backlight unit according to the invention. FIG. 5B is a perspective view illustrating an assembled state of the backlight unit of FIG. 5A.

Referring to FIGS. 5A and 5B, the PCB 163 may have a bar shape which defines an upper surface 163a, a lower surface 163b, and side surfaces 163c and 163d of the PCB 163. At least one light source 161 may be mounted on one side surface 163c among the side surfaces 163c and 163d of the PCB 163. Referring to FIGS. 5A and 5B, although an insulating layer is not shown separate from a light source, the feature labeled 161 may be considered as representing an insulating layer within 161 and adjacent to the side surface 163c of the PCB 163 so as to be disposed between a light source within 161 and the PCB 163.

The PCB 163 may be one of a metal printed circuit board (“MPCB”) and a metal core printed circuit board (“MCPCB”), and may have a thickness “t” in a range of about 0.5 millimeter (mm) to about 3.0 millimeters (mm).

A length of the PCB 163 may be coupled to and extend along an edge of the lower frame 190 (refer to FIG. 1). In particular, the lower surface 163b of the PCB 163 and the bottom portion 191 of the lower frame 190 may be coupled to each other such as by being screw-coupled to each other. The bottom portion 191 of the lower frame 190 may have a quadrangular planar shape and the side wall portion 193 is bent upwardly from an edge of the bottom portion 191 to extend therefrom. The PCB 163 may contact the lower frame 190 to transfer heat therebetween, but the invention is not limited thereto. In the exemplary embodiment of the LCD device 100 according to the invention, a portion of the side wall portion 193 at a side of the lower frame 190 at which the PCB 163 is disposed may be omitted.

Accordingly, at least a portion of the PCB 163, for example, the other side surface 163d among the side surfaces 163c and 163d of the PCB 163 opposing the one side surface 163c on which the light source 161 is mounted, may be exposed externally with respect to the lower frame 190.

The light source 161 may be a light generating and emitting element, and temperature thereof may rapidly increase over the course of usage time. In this regard, the exemplary embodiment of the LCD device 100 according to the invention may form the PCB 163, on which the light source 161 is mounted, using a metal material having a predetermined thickness “t”, and may dispose a portion of the PCB 163 to be exposed directly to an external environment relative to components of the backlight unit, thereby relatively rapidly dissipating high-temperature heat generated in the light source 161.

In addition, the exemplary embodiment of the LCD device 100 according to the invention may further include the extrusion bar 130 coupled to the PCB 163 to be disposed above the light source 161, where the extrusion bar 130 also externally dissipates heat generated in the light source unit 160 while supporting the lower edge of the display panel 110.

The extrusion bar 130 may be coupled to a side surface of the PCB 163 such as being screw-coupled at the side surface 163c of the PCB 163 on which the light source 161 is mounted. The PCB 163 may contact the extrusion bar 130 to transfer heat therebetween, but the invention is not limited thereto. The extrusion bar 130 may define the fixing portion 131 having a bar shape and the support portion 133 which extends from the fixing portion 131. In addition, the buffer 135 may be disposed on the lower surface of the fixing portion 131. The adhesive 137 which fixes the display panel 110 to the extrusion bar 130 may further be disposed on the upper surface of the support portion 133.

The exemplary embodiment of the LCD device 100 according to the invention may rapidly dissipate high-temperature heat generated by the light source 161 outwards both through the PCB 163 having at least a portion thereof exposed external to the backlight unit, and through the bottom portion 191 of the lower frame 190 and the extrusion bar 130 which are both coupled to the PCB 163.

In addition, the exemplary embodiment of the LCD device 100 according to the invention may further include the heat dissipation tape 170 extended to be attached to the upper surface 163a of the PCB 163, to the other side surface 163d of the PCB 163 which is exposed externally, to the extrusion bar 130, and the like.

The heat dissipation tape 170 may increase emissivity of infrared light generated on a surface of the PCB 163, thereby significantly enhancing radiant heat dissipation efficiency.

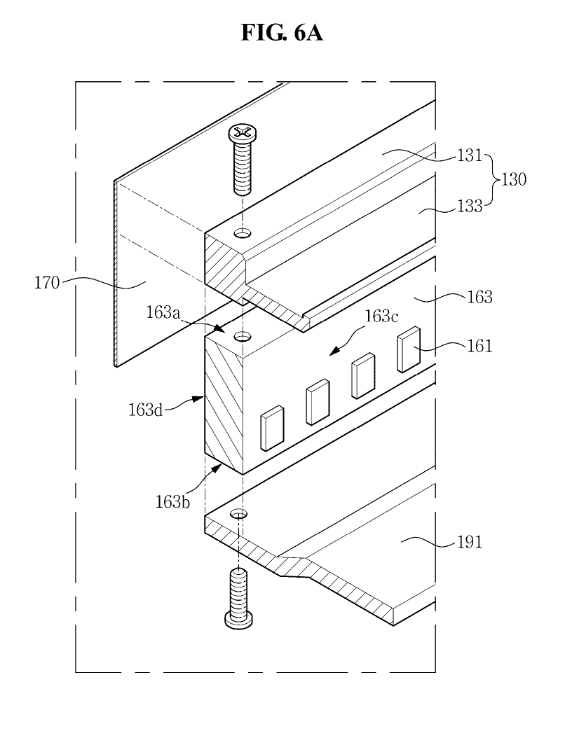

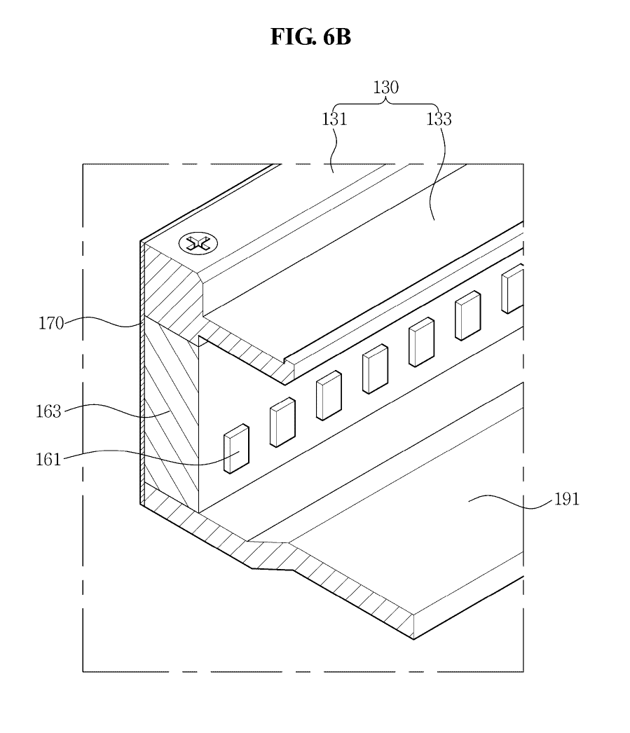

FIG. 6A is an exploded perspective view schematically illustrating another exemplary embodiment of a backlight unit according to the invention. FIG. 6B is a perspective view illustrating an assembled state of the backlight unit of FIG. 6A. With regard to a description pertaining to a light source unit in FIGS. 6A and 6B which is the same as that of the light source unit 160 provided in FIGS. 5A and 5B, the repetitive description will be omitted.

Referring to FIGS. 6A and 6B, a PCB 163 may have a bar shape which defines an upper surface 163a, a lower surface 163b, and side surfaces 163c and 163d of the PCB 163. At least one light source 161 may be mounted on one side surface 163c side surfaces 163c and 163d of the PCB 163. Referring to FIGS. 6A and 6B, although an insulating layer is not shown separate from a light source, the feature labeled 161 may be considered as representing an insulating layer within 161 and adjacent to the side surface 163c of the PCB 163 so as to be disposed between a light source within 161 and the PCB 163.

The PCB 163 may be one of a metal printed circuit board (“MPCB”) and a metal core printed circuit board (“MCPCB”). A length of the PCB 163 may be coupled to and extend along an edge of a bottom portion 191 of the lower frame 190 (refer to FIG. 1). In particular, the lower surface 163b of the PCB 163 and the bottom portion 191 of the lower frame 190 may be coupled to each other such as by being screw-coupled to each other.

In addition, the exemplary embodiment of the backlight unit may further include an extrusion bar 130 coupled to the PCB 163 to be disposed above the light source 161, where the extrusion bar 130 also externally dissipates heat generated in the light source unit 160 while supporting the lower edge of the display panel 110. The extrusion bar 130 may be coupled to the PCB 163 such as being screw-coupled to the upper surface 163a of the PCB 163.

Further, the exemplary embodiment of the backlight unit may further include a heat dissipation tape 170 attached to an externally exposed side surface 163d of the PCB 163, to the extrusion bar 130, and the like. While the heat dissipation tape 170 in FIG. 6B is illustrated exposing an upper surface of the fixing portion 131 of the extrusion bar 130, the invention is not limited thereto. In an exemplary embodiment the heat dissipation tape 170 may overlap an upper surface of the fixing portion 131 of the extrusion bar 130 such as illustrated in FIG. 5B.

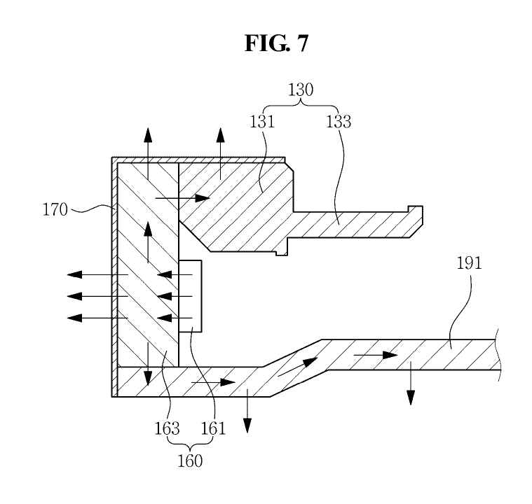

FIG. 7 is a cross-sectional view schematically illustrating a path of heat generated in a light source of an exemplary embodiment of a backlight unit according to the invention.

Referring to FIG. 7, a relatively large amount of heat generated by the light source 161 when the light source 161 is driven may be initially transmitted to a first side surface 163c (refer to FIGS. 5A and 6A) of the PCB 163 that includes or may be formed of a metal material. Arrows overlapping the light source 161 in FIG. 7 indicate transmission of heat from the light source to the PCB 163.

The heat initially transmitted to the PCB 163 may be relatively rapidly and efficiently dissipated through a second side surface 163d (refer to FIGS. 5A and 6A) of the PCB 163 externally exposed from the lower frame 190. The heat dissipated through the second side surface 163d of the PCB 163 may be transmitted through the heat-dissipating tape 170 on the second side surface 163d of the PCB 163 externally exposed from the lower frame 190. If the heat-dissipating tape 170 is on the upper surface 163a (refer to FIGS. 5A and 6A) of the PCB 163, the heat may also be dissipated through the upper surface 163a of the PCB 163 and through the heat-dissipating tape 170 on the upper surface 163a of the PCB 163.

The heat initially transmitted through the first side surface 163c of the PCB 163 may be relatively rapidly and efficiently dissipated through a body of the PCB 163 and back through the first side surface 163c of the PCB 163 to the extrusion bar 130 which is coupled to the upper surface 163a or the first side surface 163c of the PCB 163. If the heat-dissipating tape 170 is on the upper surface of the extrusion bar 130, the heat may also be dissipated through the upper surface of the extrusion bar 130 and through the heat-dissipating tape 170 on the upper surface of the extrusion bar 130.

The heat initially transmitted through the first side surface 163c of the PCB 163 may be relatively rapidly and efficiently dissipated through a body of the PCB 163 and through a lower surface 163b (refer to FIGS. 5A and 6A) of the PCB 163 to the bottom portion 191 of the lower frame 190 (refer to FIG. 1) which is coupled to the lower surface 163b of the PCB 163.

As set forth above, according to one or more exemplary embodiments, the backlight unit with one or more heat dissipating members and the LCD device including the same may enhance heat dissipation efficiency by a metal-material PCB having relatively high thermal conductivity and having a predetermined thickness, and by exposing the highly thermally conductive PCB directly to an external environment relative to the backlight unit.

In addition, the backlight unit with one or more heat dissipating members and the LCD device including the same may enhance heat dissipation efficiency by thermally contacting the PCB, on which the light source is mounted, to the metal frame (e.g., a lower frame, a extrusion bar, etc.) which accommodates the respective components of the LCD device therein. The PCB may be in direct contact with the metal frame, but the invention is not limited thereto.

Further, the backlight unit with one or more heat dissipating members and the LCD device including the same may include the heat dissipation tape as a heat dissipating member, where the heat dissipation tape has the microcavity structure and the microcavity-structure heat dissipation tape is disposed on the externally exposed portion of the PCB on which the light source is mounted.

From the foregoing, it will be appreciated that various exemplary embodiments in accordance with the present disclosure have been described herein for purposes of illustration, and that various modifications may be made without departing from the scope and spirit of the present teachings. Accordingly, the various exemplary embodiments disclosed herein are not intended to be limiting of the true scope and spirit of the present teachings. Various features of the above described and other exemplary embodiments can be mixed and matched in any manner, to produce further exemplary embodiments consistent with the invention.

What is claimed is:

1. A backlight unit comprising:
a light source which generates light;
a printed circuit board on which the light source is mounted; and
a lower frame in which the light source and the printed circuit board are accommodated,
wherein the lower frame comprises:
a bottom portion having a planar shape; and
a side wall portion bent from an edge of the bottom portion to extend therefrom,
wherein
the side wall portion defines an aperture at the edge of the bottom portion,
the printed circuit board is disposed at the aperture defined by the side wall portion of the lower frame, and
a portion of the printed circuit board disposed at the aperture is exposed outside the backlight unit.

2. The backlight unit of claim 1, wherein the aperture has a substantially same planar area as that of a surface of the printed circuit board which is disposed at the aperture.

3. The backlight unit of claim 1, wherein the light source is a light emitting diode.

4. The backlight unit of claim 1, wherein the printed circuit board is one of a metal printed circuit board and a metal core printed circuit board.

5. The backlight unit of claim 1, wherein the printed circuit board includes at least one of stainless steel, aluminum, an aluminum alloy, magnesium, a magnesium alloy, copper, a copper alloy and an electro-galvanized steel sheet.

6. The backlight unit of claim 1, wherein the printed circuit board disposed at the aperture is coupled to the bottom portion and heat is transferred between the printed circuit board and the bottom portion coupled to each other.

7. The backlight unit of claim 6, wherein the printed circuit board is screw-coupled to the bottom portion and the heat is transferred between the printed circuit board and the bottom portion screw-coupled to each other.

8. The backlight unit of claim 1, further comprising a light source unit comprising therein:
the light source which generates the light,
the printed circuit board which is disposed at the aperture, and
an insulating layer between the light source and the printed circuit board.

9. The backlight unit of claim 1, wherein the printed circuit board has a thickness in a range of about 0.5 millimeter to about 3.0 millimeters.

10. The backlight unit of claim 1, further comprising a heat-dissipating extrusion bar coupled to the printed circuit board which is disposed at the aperture,
wherein
heat is transferred between the heat-dissipating extrusion bar and the printed circuit board coupled to each other, and
the heat-dissipating extrusion bar coupled to the printed circuit board is disposed above the light source.

11. The backlight unit of claim 10, wherein the heat-dissipating extrusion bar is screw-coupled to the printed circuit board which is disposed at the aperture and the heat is transferred between the heat-dissipating extrusion bar and the printed circuit board screw-coupled to each other.

12. The backlight unit of claim 10, wherein the heat-dissipating extrusion bar includes at least one of stainless steel, aluminum, an aluminum alloy, magnesium, a magnesium alloy, copper, a copper alloy and an electro-galvanized steel sheet.

13. The backlight unit of claim 1, further comprising a heat-dissipating tape attached to a surface of the printed circuit board which is disposed at the aperture, the surface of the printed circuit board to which the heat-dissipating tape is attached being exposed outside the backlight unit.

14. The backlight unit of claim 13, wherein the heat-dissipating tape defines a microcavity structure.

15. A liquid crystal display device comprising:
a display panel which displays an image using a light; and
a backlight unit which provides the light to the display panel, the backlight unit comprising:
a light source which generates and provides the light;
a printed circuit board on which the light source is mounted; and
a lower frame in which the display panel, the light source and the printed circuit board are accommodated,
wherein the lower frame comprises:
a bottom portion having a planar shape; and
a side wall portion bent from an edge of the bottom portion to extend therefrom,
wherein
the side wall portion defines an aperture at the edge of the bottom portion,
the printed circuit board is disposed at the aperture defined by the side wall portion of the lower frame, and
a portion of the printed circuit board disposed at the aperture is exposed outside the backlight unit.

16. The liquid crystal display device of claim 15, wherein the aperture has a substantially same planar area as that of a surface of the printed circuit board which is disposed at the aperture.

17. The liquid crystal display device of claim 15, wherein the printed circuit board which is disposed at the aperture is coupled to the bottom portion and heat is transferred between the printed circuit board and the bottom portion coupled to each other.

18. The liquid crystal display device of claim 15, further comprising a heat-dissipating extrusion bar coupled to the printed circuit board which is disposed at the aperture,
wherein
heat is transferred between the heat-dissipating extrusion bar and the printed circuit board coupled to each other, and
the heat-dissipating extrusion bar coupled to the printed circuit board is disposed above the light source.

19. The liquid crystal display device of claim 18, wherein the heat-dissipating extrusion bar defines a support portion thereof to support the display panel thereon.

20. The liquid crystal display device of claim 15, further comprising a heat-dissipating tape attached to a surface of the printed circuit board which is disposed at the aperture, the surface of the printed circuit board to which the heat-dissipating tape is attached being exposed outside the backlight unit.
